(19) United States
(12) Patent Application Publication
(10) Pub. No.: US 2026/0213482 A1
(43) Pub. Date: Jul. 23, 2026

(54) CURRENT TRANSFER DEVICE FOR A ROTOR OF AN ELECTRIC MACHINE

(71) Applicant: Schaeffler Technologies AG & Co. KG, Herzogenaurach (DE)

(72) Inventor: David Lang, Bubenreuth (DE)

(73) Assignee: Schaeffler Technologies AG & Co. KG, Herzogenaurach (DE)

(21) Appl. No.: 19/138,394

(22) PCT Filed: Nov. 10, 2023
(86) PCT No.: PCT/DE2023/100859

§ 371 Date: Jun. 12, 2025

(30) Foreign Application Priority Data
Dec. 14, 2022 (DE) 10 2022 133 206.3

(51) Int. Cl. H01R 39/38; H01R 4/34; H01R 39/26; H01R 43/16; H02K 5/14; H02K 11/40

(52) U.S. Cl. CPC H01R 39/381; H01R 4/34; H01R 39/26; H01R 39/383; H01R 43/16; H02K 5/148; H02K 11/40; H01R 2201/26

(57) ABSTRACT

A current transfer device for a rotor of an electric machine includes a first annular disc made of sheet metal. Electrical contacts are located on the first annular disc, within guides and are biased by spring elements. A receiving socket is formed monolithically with the first annular disc and extends radially outward therefrom. The receiving socket includes a first tab-like portion and a second tab-like portion that is bent in such a way that the first tab-like portion rests thereon.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100859, filed on Nov. 10, 2023, designating the United States of America, which in turn claims the benefit of priority under 35 U.S.C. § § 119, 365 of German Patent Application No. 102022133206.3, filed on Dec. 14, 2022, the contents of which are relied upon and incorporated herein by reference in their entirety.

### FIELD OF THE DISCLOSURE

The disclosure relates to a current transfer device for a rotor of an electric machine, such as an electric machine within a drive train of an electrically driven motor vehicle, comprising a first annular disc made of sheet metal which encompasses a rotor shaft of the rotor circumferentially and can be positioned in a non-rotatable manner with respect thereto, wherein at least one electrical contact is arranged on the first annular disc, which is subjected to a spring force in the radial direction by a spring element and is linearly displaceably guided in the direction of the rotor shaft in a guide, which electrical contact thus electrically conductively contacts at least one circumferentially extending conducting path of the rotor shaft, wherein at least one first receiving socket extending outward therefrom in the radial direction is arranged on the first annular disc, via which the current transfer device is couplable to an electrical conductor.

### BACKGROUND OF THE DISCLOSURE

JP 2017-11 884 A, which is considered to be generic, discloses a current transfer device as mentioned above. A thin-walled annular disc carrying several contacting means distributed around the circumference completely encompasses a rotor shaft. A tab-like receiving socket extends radially away from the annular disc. The latter can be used to connect the current transfer device to an electrical conductor. It can be seen that the receiving socket is a component joined separately to the annular disc (see FIG. 3).

DE 10 2007 059 555 A1 discloses a modular current transfer device with two ring-shaped current conducting plates, each of which is assigned a plurality of contacting means (brushes) (see FIG. 1). A one-piece foot protrudes from each power conducting plate to supply power thereto.

### SUMMARY OF THE DISCLOSURE

According to the disclosure, the first receiving socket is formed monolithically with the first annular disc and is formed from a first tab-like portion and a second tab-like portion arranged thereon, which second portion is bent so that the first portion rests thereon and wherein at least one of the two portions has a cylindrical ring protruding therefrom.

The receiving socket for electrical contact is integrated in one piece into the base plate (annular disc) made of sheet metal. Thus, the receiving socket is formed by chipless forming. This reduces the component and assembly effort, which has a positive impact on the manufacturing costs of the current transfer device. Furthermore, a one-piece design eliminates a possible increased contact resistance of several components. Furthermore, the risk of unintentional loosening of the receiving socket is significantly reduced due to the one-piece design with the annular disc.

The receiving socket can be designed as a socket with an internal thread, so that, for example, a cable lug can be attached thereto with a screw. Alternatively, a screw can be connected to the washer so that the cable lug is fastened with a nut. If two annular discs are mounted mirror-symmetrically, i.e., one per pole, and a flat screwing surface is provided, this distance can be bridged with an additional sleeve, for example.

The receiving socket extends radially out of the first ring disc. The advantage of this design is that it can facilitate a forming, in particular a bending of portions to form the receiving socket.

The receiving socket is formed from a first tab-like portion and a second tab-like portion of the first annular disc arranged thereon, wherein the second tab-like portion is bent in such a way that the first tab-like portion rests thereon, which has proven to be advantageous in terms of manufacturing technology.

In addition, the first tab-like portion has a first cylinder ring protruding therefrom and/or the second tab-like portion has a cylinder ring protruding therefrom. The advantageous effect of this design is based on the fact that it enables a fastener to be guided through the receiving socket and also allows a defined axial distance to be defined between the tab-like portions, for example, when one portion rests against the cylinder ring of the other.

The first cylinder ring may have an internal thread and/or the second cylinder ring may have an internal thread, so that a screw can be screwed into the respective cylinder ring.

Furthermore, the current transfer device has a second annular disc made of sheet metal, which circumferentially encompasses the rotor shaft of the rotor and is arranged in a non-rotatable manner on the first annular disc, wherein at least one electrical contact is arranged on the second annular disc, which is subjected to a spring force in the radial direction by a spring element and is linearly displaceably guided in the direction of the rotor shaft in a guide, which electrical contact thus electrically conductively contacts at least one circumferentially extending conducting path of the rotor shaft, wherein at least one second receiving socket is arranged on the second annular disc, via which the current transfer device is couplable to a second electrical conductor, and wherein this second annular disc is structurally identical to the first annular disc.

The identically shaped (identically constructed) design of the two annular discs can help to further reduce manufacturing costs. Thus, from a manufacturing point of view, it is advantageous to make the first annular disc and/or the second annular disc from sheet metal.

The electric machine can be designed as a separately excited synchronous machine.

The current transfer device can also be designed as a shaft grounding for the rotor shaft so that a current can be discharged from the rotor shaft.

The electric machine may be used within a drive train of a hybrid or fully electrically driven motor vehicle. For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

A electrical contact can, for example, be an electric carbon brush. In some implementations, the electrical contact is a block-like solid body made of an electrically conductive material.

The disclosure is explained below in more detail.

### BRIEF DESCRIPTION OF THE DRAWINGS

In the drawings:

FIG. 1 shows a motor vehicle having an electric drive train in a schematic block diagram;

FIG. 2 shows an electric machine having a first embodiment of a current transfer device in a schematic axial sectional view;

FIG. 3 shows a schematic representation of the electrical contact on a rotor in a perspective view;

FIG. 4 shows an embodiment of a current transfer device in two perspective views;

FIG. 5 shows a second embodiment of a current transfer device in a perspective view;

FIG. 6 shows a second embodiment of a current transfer device in a schematic axial sectional view; and

FIG. 7 shows a sheet metal section of an annular disc of the current transfer device in a plan view.

### DETAILED DESCRIPTION

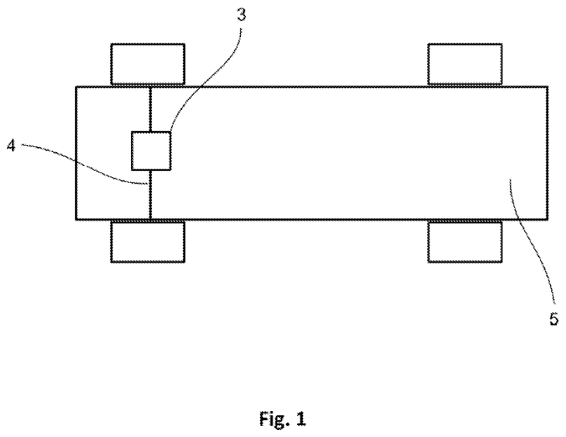

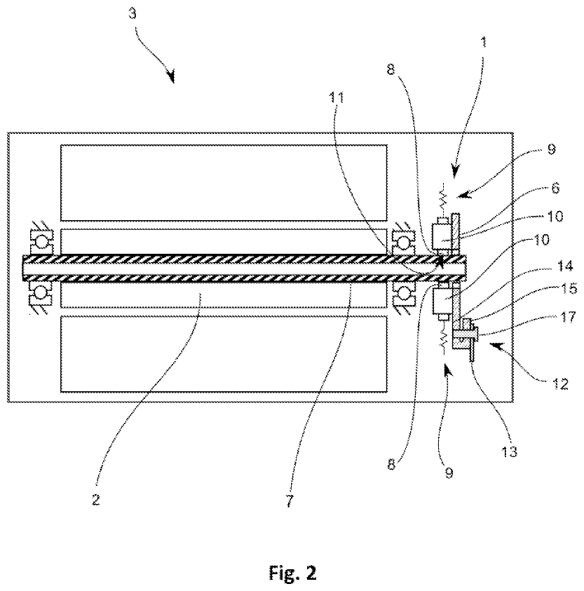

FIG. 2 shows a current transfer device 1 for a rotor 2 of an electric machine 3 configured as a radial flux machine, such as an electric machine 3 within a drive train 4 of an electrically driven motor vehicle 5, as is also outlined by way of example in FIG. 1.

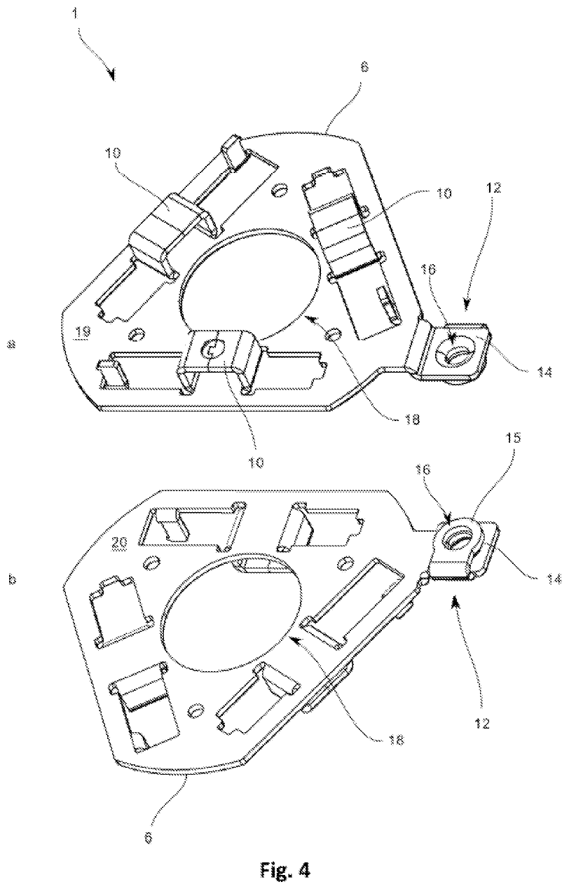

As can be clearly seen from a comparison of FIG. 2 and FIG. 4, the current transfer device 1 comprises an annular disc 6 which circumferentially encompasses a rotor shaft 7 of the rotor 2, and which is positioned in a non-rotatable manner to the rotor shaft 7. A plurality of electrical contacts 8 are arranged on the annular disc 6, which are each subjected to a spring force in the radial direction by a spring element 9 and are each linearly displaceably guided in the direction of the rotor shaft 7 in a guide 10, in that the contact 8 rests in a sliding manner against the inner walls of the guide 10.

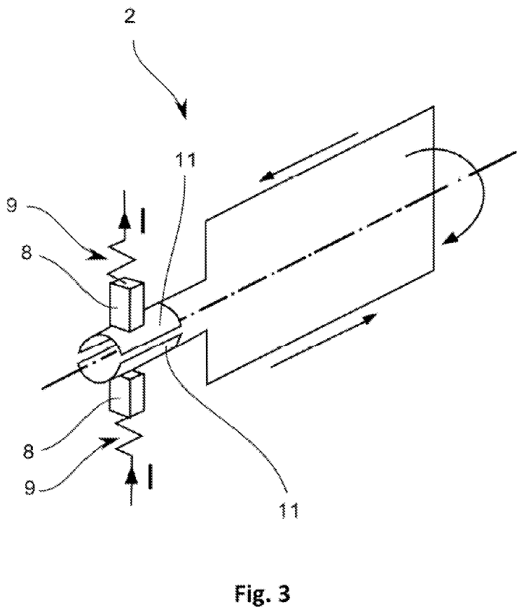

As can be seen from FIG. 3, the contacts 8 are electrically conductively contacting at least one circumferential conducting path 11 of the rotor shaft 7. In the embodiment shown in FIG. 3, the two half-shell-like conducting paths 11 form the commutator of a direct current machine. For use in a separately excited synchronous machine, as shown in FIG. 2, the conducting paths 11 are then circumferentially closed, i.e., designed in a ring shape, or only one ring-shaped conducting path 11 can be formed on the rotor 2. This design is outlined in FIG. 2 in an exemplary manner. It is understood that the current transfer device 1 can be used both for application in a direct current machine and also in a separately excited synchronous machine.

The guides 10 are formed monolithically with the annular disc 6, which is shown in FIG. 4. The annular disc 6 is formed from a sheet metal. Arranged on the annular disc 6 are tab-like portions formed by deformation, which extend out of the plane of the annular disc 6 and thus form a guide 10 for an electrical contact 8. The tab-like portions forming a guide 10 each have a rectangular basic shape, each of which has a portion extending out of the plane of the annular disc 6 by deformation and a portion extending parallel to the plane of the annular disc 6 with a free end. The free ends of the tab-like portions are fixed to each other in a form-fitting manner at least in the circumferential direction. For this purpose, a dovetail-like web is arranged at the free end of the first tab-like portion, which engages in a corresponding groove at the free end of the second tab-like portion.

The annular disc 6 further has a circular opening 18 through which the rotor shaft 7 passes, on which the tab-like portions running tangentially to the opening 18. The contact 8 and the guide 10 are essentially identical in the embodiment shown.

A first receiving socket 12 is arranged on the first annular disc 6, via which the current transfer device 1 is couplable to a first electrical conductor 13. For this purpose, the electrical conductor 13 can have, for example, a cable lug or a cable eyelet through which a fastening screw can pass to secure the electrical conductor 13 to the first receiving socket 12.

The first receiving socket 12 is formed monolithically with the first annular disc 6 and extends out of the first annular disc 6 in the radial direction. The receiving socket 12 is formed from a first tab-like portion 14 and a second tab-like portion 15 of the first annular disc 6 arranged on the first tab-like portion 14, wherein the second tab-like portion 15 is bent such that the first tab-like portion 14 rests on the second tab-like portion 15, which can be clearly understood from the illustrations in FIG. 4. The upper image a of FIG. 4 shows the upper side 19 of the annular disc 6 and the lower image b shows the lower side 20 of the annular disc 6.

The first tab-like portion 14 has a first cylinder ring 16 which protrudes therefrom in the axial direction and has an internal thread so that, for example, a fastener 17 designed as a screw can be screwed into the cylinder ring 16 and the electrical conductor 13 can thus be secured to the receiving socket 12.

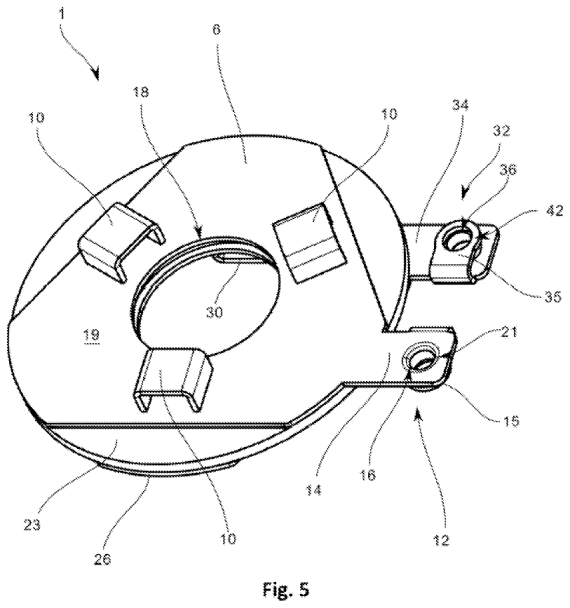

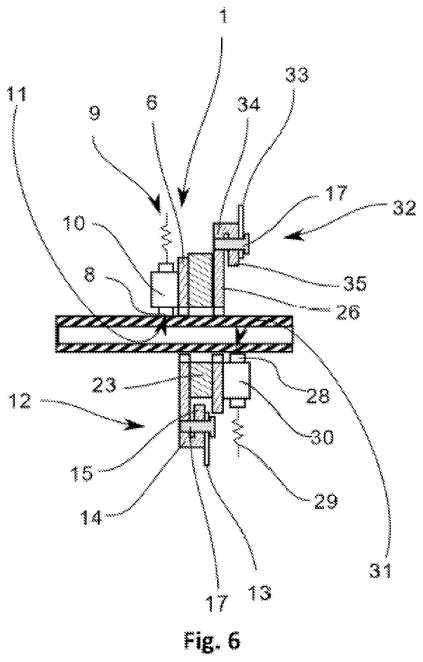

FIGS. 5 and 6 show a further embodiment of a current transfer device 1, in which the current transfer device 1 has a second annular disc 26 which circumferentially encompasses a rotor shaft 7 of the rotor 2 at least in sections and which is arranged in a non-rotatable manner on the first annular disc 6. At least one electrical contact 28 is also arranged on the second annular disc 26, which is subjected to a spring force in the radial direction by a spring element 29 and is linearly displaceably guided in the direction of the rotor shaft 7 in a guide 30. The contact 28 thus electrically conductively contacts at least one circumferential conducting path 31 of the rotor shaft 7. A second receiving socket 32 is also arranged on the second annular disc 26, via which the current transfer device 1 is couplable to a second electrical conductor 33.

For this purpose, as in the embodiment of FIGS. 2-4, a collar-like portion 14 is pulled radially out of the annular disc 6, 26 and, for example, a deep-drawn cylinder ring 36 is provided with an internal thread. To use an identical annular disc 6, 26 for both electrical poles, the tab-like portion 15, 35 is additionally bent over, which provides a second rear receiving surface. The tab-like portions 14, 34 and the tab-like portions 15, 35 each have a socket opening 21, 41 or socket opening 22, 42 for the passage of a fastener 17, such as a mounting screw. An insulating disc 23 is arranged axially between the annular discs 6, 26, which provides electrical insulation of the two annular discs 6, 26 from one another.

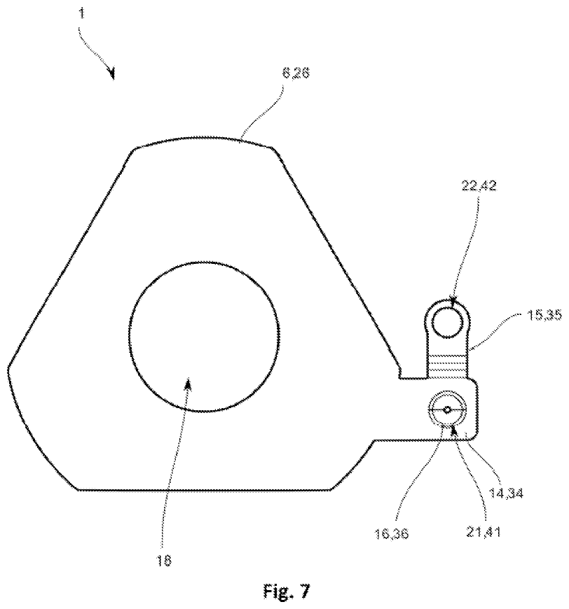

The first annular disc 6 and the second annular disc 26 are formed from a sheet metal with a substantially identical sheet metal section. This sheet metal section of the annular discs 6, 26 is shown in FIG. 7. The first annular disc 6 and the second annular disc 26 are therefore essentially made of the same parts.

FIG. 7 briefly explains how the current transfer device 1 of FIGS. 2-6 can be manufactured.

First, a first annular disc 6 is provided, which can encompass a rotor shaft 7 of the rotor 2 circumferentially at least in portions, wherein the annular disc 6 is arranged with a first tab-like portion 14 and a second tab-like portion 15 arranged on the first tab-like portion 14. This metal sheet cut is shown in FIG. 7.

Starting from the sheet metal cut shown in FIG. 7, the second tab-like portion 15 is then bent by approximately 180° so that the first tab-like portion 14 rests against the second tab-like portion 15 and thus forms a first receiving socket 12 via which the current transfer device 1 is couplable to a first electrical conductor 13. This production status can be seen, for example, in FIG. 4.

For example, to provide an internal thread in the receiving socket 12, a cylindrical ring 16, 36 can be formed in the sheet metal cut before bending by a forming step, which extends out of the plane of a tab-like portion 14, 34. The internal thread is then cut into the inner lateral surface of the corresponding cylinder ring 16, 36.

### LIST OF REFERENCE SYMBOLS

1 Current transfer device
2 Rotor
3 Electric machine
4 Drive train
5 Motor vehicle
6 First annular disc
7 Rotor shaft
8 Contact
9 Spring element
10 Guide
11 Conducting path
12 Receiving socket
13 Conductor
14 First portion
15 Second portion
16 First cylinder ring
17 Fastener
18 Opening
19 Upper face
20 Lower face
21 Socket opening
22 Socket opening
23 Insulation disc
26 Second annular disc
28 Contact
29 Spring element
30 Guide
31 Conducting path
32 Receiving socket
33 Conductor
34 First portion
35 Second portion
36 First cylinder ring
41 First socket opening
42 Second socket opening

1. A current transfer device for a rotor of an electric machine, comprising:
a first annular disc made of sheet metal and configured to extend circumferentially about a rotor shaft of the rotor in a non-rotatable manner;
at least one electrical contact arranged on the first annular disc, which is subjected to a spring force in a radial direction by a spring element and is linearly displaceably guided in the direction of the rotor shaft by a guide, wherein the electrical contact is configured to electrically conductively contact at least one circumferentially extending conducting path of the rotor shaft; and
at least one first receiving socket that extends radially outward from a portion of the first annular disc, wherein the at least one first receiving socket is formed monolithically with the first annular disc and includes a first tab-like portion and a second tab-like portion that is bent such that the first tab-like portion rests thereon, and wherein at least one of the first and second tab-like portions has a cylinder ring protruding therefrom.

2. The current transfer device of claim 1, wherein one of the first and second tab-like portions includes the cylinder ring, and wherein the cylinder ring has an internal thread.

3. The current transfer device of claim 1, wherein the current transfer device includes a second annular disc that is made of sheet metal and is configured to extend circumferentially about the rotor shaft of the rotor in a non-rotatable manner, wherein at least one electrical contact is arranged on the second annular disc, which is subjected to a spring force in the radial direction by a spring element and is linearly displaceably guided in the direction of the rotor shaft via a guide, wherein the at least one electrical contact arranged on the second annular disc is configured to electrically conductively contact the at least one circumferentially extending conducting path of the rotor shaft, and wherein at least one second receiving socket extends radially outward from a portion of the second annular disc and wherein the second annular disc is structurally identical to the first annular disc.

4. The current transfer device of claim 1, wherein each of the first and second tab-like portions includes cylinder rings, and at least one of the cylinder rings includes an internal thread.

5. A current transfer device for a rotor of an electric machine, the rotor having a rotor shaft provided with at least one circumferentially extending conducting path, the device comprising:
a first annular disc formed of sheet metal and configured to circumferentially extend about and be non-rotatably fixed to the rotor shaft;
a plurality of guides formed monolithically with the first annular disc;
a plurality of electrical contacts, each disposed in a respective one of the guides and biased radially inward toward the conducting path by a spring element such that each electrical contact is linearly displaceable along a radial direction to maintain sliding electrical engagement with the conducting path;
a receiving socket integrally formed with and extending radially outward from the first annular disc, the receiving socket being formed by a first tab-like portion and a second tab-like portion that is bent toward the first tab-like portion such that the first tab-like portion overlies the second tab-like portion; and
a cylinder ring projecting axially from at least one of the first and second tab-like portions, the cylinder ring defining a threaded aperture that is configured to receive a fastener for mechanically and electrically coupling an electrical conductor to the receiving socket.

6. The current transfer device of claim 5, wherein each guide is formed by two bent tab segments of the first annular disc that interlock with one another.

7. The current transfer device of claim 5, wherein each electrical contact comprises a block-shaped body of electrically conductive material.

8. The current transfer device of claim 5, wherein the cylinder ring is deep-drawn from the sheet metal that forms the first annular disc and includes an internal thread.

9. The current transfer device of claim 5, wherein the second tab-like portion is bent by an angle of approximately 180 degrees, such that the first tab-like portion rests against the second tab-like portion.

10. The current transfer device of claim 5, further comprising:
a second annular disc formed from sheet metal, the second annular disc being structurally identical and axially spaced from the first annular disc.

11. The current transfer device of claim 10, further comprising:
an insulating disc disposed between the first and second annular discs and configured to electrically isolate the first annular disc from the second annular disc.

12. The current transfer device of claim 5, wherein said device is configured to provide shaft grounding for the rotor shaft of a separately excited synchronous machine.

13. The current transfer device of claim 5, wherein the electric machine forms part of a drivetrain of at least one of a hybrid electric vehicle and a fully electric vehicle.

14. An electric machine, comprising:
a rotor having a rotor shaft; and
a current transfer device, comprising:
a first annular disc formed of sheet metal and extending circumferentially about the rotor shaft in a non-rotatable manner relative to the rotor shaft;
a plurality of guides formed of the sheet metal monolithically with the first annular disc;
a plurality of electrical contacts, each disposed in a respective one of the guides and biased radially inward toward the rotor shaft by a spring element such that each electrical contact is linearly displaceable along a radial direction to maintain electrical engagement with a conducting path of the rotor shaft; and
a receiving socket formed of the sheet metal monolithically with the first annular disc and extending radially outward therefrom, the receiving socket including a first portion and a second portion that is bent toward the first portion such that the first portion overlies the second portion.

15. The electric machine of claim 14, wherein the current transfer device further comprises:
a cylinder ring that projects axially from at least one of the first and second portions, the cylinder ring defining an aperture that is configured to receive a fastener coupling an electrical conductor to the receiving socket.

16. The electric machine of claim 15, wherein the cylinder ring defines a threaded aperture that is configured to receive the fastener therein for mechanical and electrical coupling of the electrical conductor to the receiving socket.

17. The electric machine of claim 14, wherein each guide is formed by two bent tab segments of the sheet metal extending from the first annular disc that interlock with one another.

18. The electric machine of claim 14, wherein said electric machine forms part of a drivetrain of at least one of a hybrid electric vehicle and a fully electric vehicle.

19. The electric machine of claim 14, wherein the second portion is bent by an angle of approximately 180 degrees, such that the first portion rests against the second portion.

20. The electric machine of claim 14, wherein the current transfer device further comprises:
a second annular disc formed from sheet metal, the second annular disc extending circumferentially about the rotor shaft in a non-rotatable manner relative to the rotor shaft and being structurally identical and axially spaced from the first annular disc.
